(19) United States
(12) Patent Application Publication
(10) Pub. No.: US 2003/0017088 A1
(43) Pub. Date: Jan. 23, 2003

(54) Method for simultaneous removal and sequestration of CO2 in a highly energy efficient manner

(76) Inventors: William Downs, Alliance, OH (US); Hamid Sarv, Canton, OH (US)

Correspondence Address: McDermott Incorporated, Patent Department, Alliance Research Center, 1562 Beeson Street, Alliance, OH, 44601-2196, US

(21) Appl. No.: 09/909,592

(22) Filed: Jul. 20, 2001

(51) Int. Cl. F01N 3/00; F01N 3/02; B01D 53/34

(52) U.S. Cl. 422/176; 422/168; 422/172

(57) ABSTRACT

A CO₂ removal and sequestration system uses a limestone bed of coarse crushed limestone covering pipes which carry a flue gas. The pipes have spaced openings which permit flue gas to pass into the limestone bed. Water fills the bed to about 2/3 of the height of the limestone, which is higher than the depth of the pipes. The water flows through the bed at a predetermined rate. The bed is arranged as a series of parallel rows of beds with open channels between each pair of adjacent rows. The open channels are alternating water inlet and outlet channels. A flue gas delivery system includes headers and manifolds for distributing the flue gas at sufficient pressure to overcome existing water pressure at the pipe openings. The process includes the steps of removing CO₂ from the flue gas in the bed, dissolving CO₂ in the water in the bed, and then returning the water/CO₂ to the ocean, river, lake or other area which may be used to store CO₂.

### FIELD AND BACKGROUND OF THE INVENTION

The present invention relates generally to the field of large scale sequestration of CO₂ from industrial gases, and in particular to a new and useful method of more efficiently removing and sequestering CO₂ generated by combustion of fossil fuels in power generation plants.

Large-scale sequestration of CO₂ from power plant processes is a relatively new field. The need to control CO₂ emissions on a global scale is widely recognized, and electric power generation plants which combust fossil fuels to create power are primary targets. In North America, coal is the primary fuel used for electric power generation.

One of the control strategies proposed for CO₂ capture/sequestration involves concentrating the CO₂ contained in the boiler flue gas, followed by liquefaction of the CO₂. The liquid CO₂ can then be transported by pipeline to final storage sites, including the deep oceans, underground aquifers, depleted gas wells, and other, similar locations.

Several methods which have been proposed for capturing and concentrating CO₂ in flue gas include: absorption/stripping, semi-permeable membranes, substituting oxygen for combustion air and varying combinations of these approaches. In any of these cases, the CO₂ must be dehydrated and acid gases must be removed before liquefying the CO₂ by compression and cooling. Once the CO₂ is liquefied, it can be pumped to a final storage site.

Direct injection of CO₂ into the oceans has come under serious consideration in recent years. Since CO₂ is an acidic gas, direct injection of CO₂ can cause local pH levels at the injection point to decrease significantly to less than 3.5. Normal seawater has a pH generally above 7.8.

Research performed at the University of California at Santa Clara and at the Lawrence Livermore National Laboratory has suggested that the absorption of CO₂ from power plant combustion gases directly into seawater is a possible means for sequestering CO₂. Conceptually, flue gases would be contacted with water and limestone using a modified SO₂ wet scrubber apparatus in conjunction with a porous carbonate bed and carbonic acid/water solution. Using this method, the absorption rate and capacity take advantage of relatively high partial pressure of CO₂ present in most flue gases.

This proposed method involves reacting CO₂ with mildly alkaline limestone, thereby buffering the pH. The minimum pH during CO₂ contact with water and limestone will be about 6.5. Once the CO₂ containing seawater is released into the ocean and returns to equilibrium with the open water, the pH will be above 7.8, while reducing the shock to the open water. Further analysis of this proposal has suggested that dissolved calcium in the seawater will increase by only 0.6% and bicarbonate will increase by only about 5%. Although the environmental consequences of these changes in the seawater composition are still unknown, the changes are modest compared to the effect of concentrated, liquefied CO₂ addition to seawater. Unfortunately, there are several limiting factors for using any of the methods above. Foremost, the quantities and volumes of CO₂ that need to be processed preclude a practical configuration of any conventional wet scrubber apparatus. Another problem is that all of these CO₂ removal methods are extremely energy intensive. Therefore, these methods have parasitic power losses that severely reduce the attractiveness of any of these CO₂ removal scheme.

Parasitic power loss can be described as follows. The energy usage of auxiliary equipment at a power plant that consumes electrical energy is called aux power or parasitic power. This includes such equipment as the forced draft fan(s), induced draft fan(s), the transformer rectifier (TR) sets on an electrostatic precipitator, the feed water pump, and other like devices. The net generating capacity of a power plant, sometimes called the busbar power, is the difference between the gross power output of the electric generator and the parasitic power. It is convenient and customary to express the parasitic power as a percentage of the gross generator output. For example, a flue gas desulfurization (FGD) system based on the limestone forced oxidation process uses about 1.4% parasitic power.

The two technologies most often cited for consideration for CO₂ control on coal fired power plants are “absorption/stripping” and “oxygen fired combustion.” The parasitic power requirements for these two technologies are described below.

Absorption-stripping describes a class of processes that are used to remove and concentrate an “impurity” in a gas stream. In the case of CO₂ in flue gas, a two-tower arrangement is used. The CO₂ containing flue gases pass through a packed tower where they contact an organic solution such as monoethanolamine (MEA) in a countercurrent arrangement. The CO₂ is selectively absorbed into the organic solution. The CO₂ saturated organic solution is then transferred to a second column where the solution is contacted with steam. In this fashion the CO₂ is stripped from the organic solvent into a steam-CO₂ gas mixture. The steam is then condensed leaving a concentrated CO₂ stream.

All processes that involve absorption/stripping for CO₂ removal and concentration are heavily energy intensive. For example, the reboiler on the CO₂ stripper column has a heat duty approaching 50% of the power boiler heat input. This heat demand can be met typically with 50-psi steam. At the least, this causes an intrusion into the steam cycle that robs power from the generator. In one study, the existing condensing steam turbine would have to be replaced by two steam turbines, the first being a back-pressure turbine and the second a condensing turbine. To compound the problem, since the absorption/stripping process reduces the thermal cycle efficiency, the additional inefficiency increases the heat rejection that increases the thermal pollution proportionately. This loss is not strictly a parasitic loss. Rather, it is actually a reduction in the gross output from the generator.

A Department of Energy (DOE) sponsored study looked at the effect of retrofitting MEA based absorption on an existing 434 MWe power plant. The Study showed that the electrical production delivered to the busbar would decrease from 434 MWe to 260 MWe. But, the amount of fuel consumed by the power plant would remain unchanged. The energy conversion efficiency of this plant would drop from 36% to 21%. The total parasitic power would be about 44% for this plant equipped with MEA absorption-stripping compared to 6.4% for the base plant (for further discussion, see the article by John Marion, et. al., “Engineering Feasibility of CO₂ Capture on an Existing US Coal-fired Power plant”, 26^{th} International Conference on Coal Utilization & Fuel Systems, Clearwater, Fla., Mar. 5-8, 2001, incorporated by reference herein).

An oxygen-fired boiler is one where molecular oxygen replaces air as the oxidizer of the fossil fuel. Air contains about 21% by volume oxygen with most of the balance being nitrogen. In the oxygen fired boiler the oxygen constitutes better than 98% of the volume with the balance being nitrogen and argon. During normal combustion with air, much of the thermal energy released by the combustion process is used to heat the nitrogen in the air. But, with oxygen combustion, there is little nitrogen to take out the thermal energy release. The result is that oxygen combustion has the potential to produce such hot, high temperature flames that the materials of construction of conventional power boilers would fail. The concept of flue gas recirculation with oxygen firing was devised to avoid that problem. In fact, oxygen firing as a strategy to produce a CO₂-rich flue gas will use no more auxiliary or parasitic power consumption within the Boiler Island than a conventional coal fired boiler operating with air. However, when the power required to separate oxygen from air and the power required to cool and condense the CO₂ for ultimate transport to its final point of sequestration are factored in the calculations, the energy picture changes dramatically. If this technology were applied to the existing 434 MWe power plant noted above, the net available power to the busbar would decrease from 434 MWe to 280 MWe. But the energy input would also drop by about 2%. The total parasitic power requirement of this plant equipped with oxygen firing would be about 40% compared to 6.4% for this plant operating in its design mode.

Large parasitic losses inherent to all of the CO₂ sequestration processes that have been proposed up until now are a major reason why there is political and economic resistance to implementing the processes, especially in the United States. A sequestration process is needed which minimizes or substantially reduces the energy losses associated with these processes.

### SUMMARY OF THE INVENTION

It is an object of the present invention to provide a CO₂ sequestration system which overcomes many of the problems associated with existing processes.

It is a further object of the invention to provide a CO₂ sequestration system which improves upon known CO₂ processes by reducing the energy losses relative to CO₂ removal and disposal.

Accordingly, a sequestration system is provided in which a limestone bed of coarse crushed limestone covers pipes which carry a flue gas. The pipes have spaced openings which permit flue gas to pass into the limestone bed. Water fills the bed to about ⅔ of the height of the limestone bed, which is higher than the depth of the pipes. The water flows through the bed at a predetermined rate. The facility is arranged as a series of parallel rows of beds with open channels between each pair of adjacent rows. The open channels are alternating water inlet and outlet channels. A flue gas delivery system includes headers and manifolds for distributing the flue gas at sufficient pressure to overcome existing water pressure at the pipe openings.

In an embodiment of the facility provided in a coastal setting, the beds are arranged above the high tide mark and oriented so that seawater which is pumped into the bed from below will flow back into the ocean under the force of gravity. Gratings can be used to retain limestone in the beds adjacent water outlets into the ocean.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a plan view of limestone beds for sequestering CO₂ according to the invention;

FIG. 2A is a side elevational view of a section of a water inlet channel wall of the bed of FIG. 1;

FIG. 2B is a side elevational view of a section of a water outlet channel wall of the bed of FIG. 1;

FIG. 3 is an end sectional view of a bed row of FIG. 1; and

FIG. 4 is a top perspective view of a flue gas supply system for the bed of FIG. 1.

### DESCRIPTION OF THE PREFERRED EMBODIMENTS

A system for efficiently removing CO₂ from flue gases produced by combustion of fossil fuels in power plants is provided which modifies and improves upon previous ideas by using a water-filled limestone bed (rather than a scrubber apparatus) to sequester CO₂.

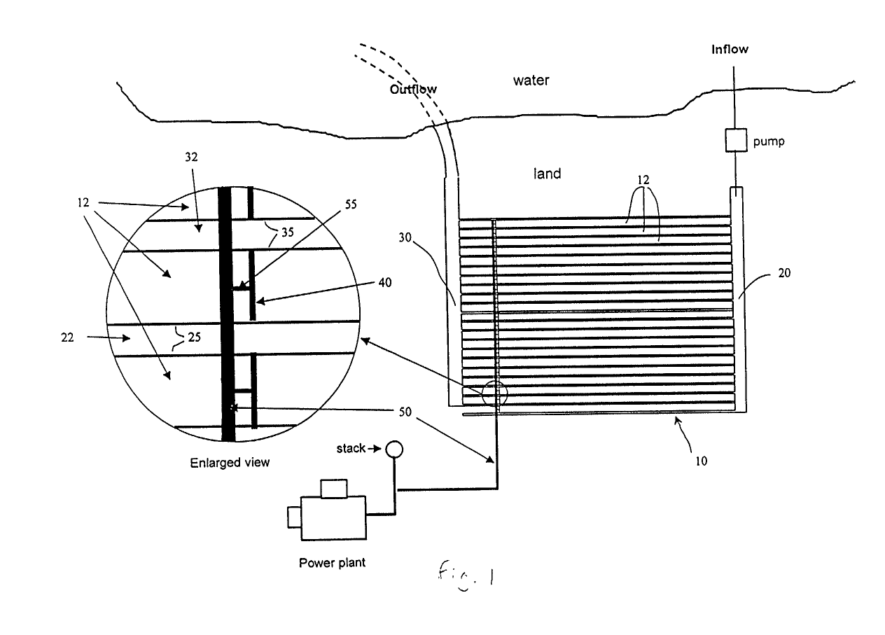

Referring now to the drawings, in which like reference numerals are used to refer to the same or similar elements, FIG. 1 shows a top plan view of a limestone bed 10 having a water supply channel 20 at one side and a water drain channel 30 at the other. The rows 12 of limestone have open rows between them through which are alternately water inlet channels 22 and water outlet channels 32. Inlet channels 22 are defined by walls 25, while Outlet channels 32 are defined by walls 35.

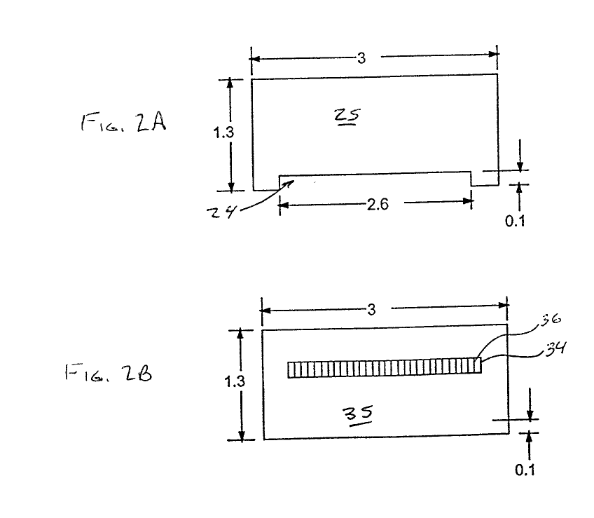

The construction of the walls 25, 35 between rows 12 depends on whether the adjacent open channel is a water inlet channel 22 or water outlet channel 32. As seen in FIG. 2A, the walls 25 in the water inlet channels 22 have a slot 24 at the bottom of the wall 25 for permitting water to pass underneath the wall 25 into bed row 12. Slots 24 are provided at spaced intervals along the length of bed row 12 in the water inlet channel 22. FIG. 2B shows a water outlet channel wall 35 having a grated passage 34 through the wall 35 positioned about ⅔ up the wall 35. Rebar or other similar material may be used to form grate 36 for preventing limestone from being entrained in the water flow through the row 12 and out the passage 34 into water outlet channel 32. The grated passages 34 are spaced all along the walls 35 of each water outlet channel 32.

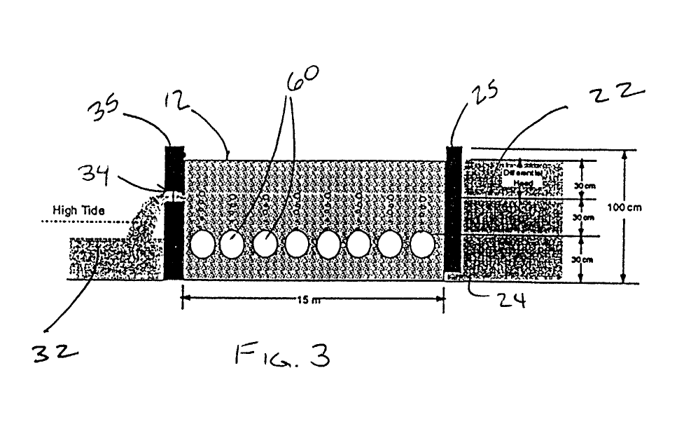

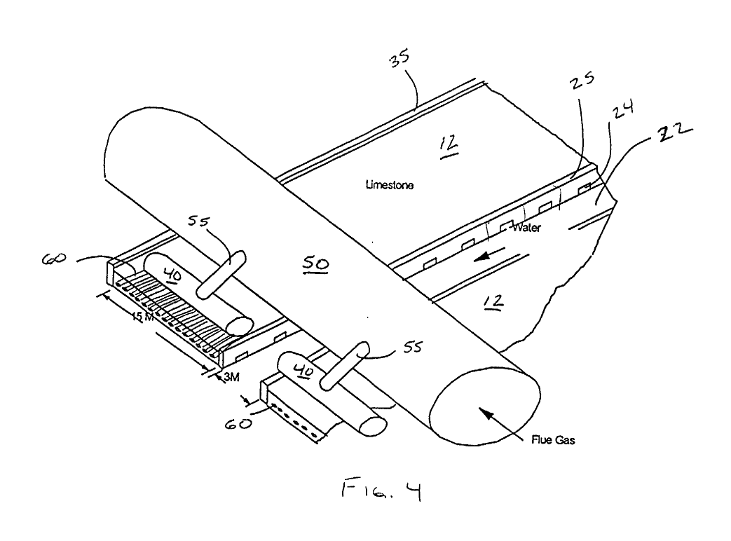

As seen in FIGS. 3 and 4, flue gases are provided to the limestone bed 10 through perforated tubes 60 buried in each limestone row 12. The perforations allow flue gas containing CO₂ to percolate through the bed row 12 limestone and water.

In a preferred embodiment, a main flue 50 is oriented to run perpendicular to the bed rows 12. The flue 50 diameter may decrease toward the end of the flue 50 farthest from the power plant where CO₂ is generated. At each row 12, a receiving manifold 40 is connected the main flue 50 by a tube 55. The receiving manifold 40 is then connected to each pipe 60 buried within the bed row 12. The flue 50 may be supported periodically on the channel walls 25, 35 and have expansion joints to account for thermal changes.

Using the water supply and outlet channels 22, 32, each row 12 in the bed 10 is kept about ⅔ filled with water. The required size of a limestone bed 10 according to the method of the invention for effectively removing CO₂ from the flue gases is determined in the following manner.

Assuming a limestone bed is one meter deep and 15 meters wide, the length of the bed for removing an effective amount of CO₂ from flue gases provided via tubes buried in the limestone can be calculated. The pipes are buried ¼ meter below the water level (⅔ meter).

The water flows through the bed at a rate determined by the following equations:

2Nₑᵤ=(1000/7.5N_{Re}+2.33)L/D_{eq} (1)

Nₑᵤ=ΔP/ (ρ_{f}υ²ₘ/g_{c}) (2)

υₛ=υₘε (3)

D_{eq}=⅔ (ε/(ε−1)) (D₃₂/φ) (4)

Nᵣₑ=ρ_{f}υₘD_{eq}/μ_{f} (5)

where:

Nₑᵤ is Euler's Number

Nᵣₑ is Reynold's Number

D_{eq} is the equivalent diameter

D₃₂ is the Sauter mean diameter is the shape factor

φ is the shape factor

υₘ is the mean fluid velocity

υₛ is the superficial velocity

ε is the void fraction

μ_{f} is the fluid viscosity

ρ_{f} is the fluid density

ΔP is pressure drop

L is path length

g_{c} is gravitational constant

The limestone beds have been sized to permit the required quantity of water to pass through the limestone beds with a driving force of 25 cm of water or less. The driving force is defined as the difference in the liquid level at the inlet channel and the liquid level in the limestone bed. The movement of the water is described in greater detail below.

In order to solve the above equations for υₛ, we must specify the void fraction, ε, and Sauter mean diameter for the limestone bed. The void fraction is an uncontrolled property of the system. However, the Sauter mean diameter can be specified over a broad range. The Sauter mean diameter also relates to the specific surface area of the limestone by the following relationship:

Sₚ=6φ/ρD₃₂ (6)

where:

ρ is the particle density

Sₚ is the specific surface area

The Sauter mean diameter is the surface area weighted mean diameter of a distribution of particle sizes. Finely ground limestone as used in limestone based wet scrubbers in the utility industry to capture SO₂ is usually ground a Sauter mean diameter of 4 to 12 microns. Preferably, for the beds of the invention, the crushed limestone has a Sauter mean diameter in the range of 5-15 mm. Using a coarser ground stone will provide a linear pressure drop variation with the Sauter mean diameter, and a coarse bed can operate without significant entrainment losses of limestone particles from the bed. The energy expense for pulverizing the amount of limestone needed for CO₂ removal could be excessive as well. Thus, in a preferred embodiment, limestone having sizes distributed from 2-30 mm was used. The Sauter mean size was determined to be 8.66 mm. Crushed limestone typically has a void fraction of about 50% and a shape factor of 1.6. Using this information to solve equation (4) yields an equivalent diameter of 3.6 mm. The superficial velocity under these conditions, including a driving force of 25 cm is found to be about 32.5 meters of water per hour.

Based upon information available from previous studies, the quantity of water required to pass through the bed to capture CO₂ is estimated to be approximately 1650 metric tons of seawater per metric ton of CO₂ captured. Approximately 1 metric ton of CO₂ is generated per hour for each MWe of generating capacity of a coal-fired power plant. Thus, if 90% of the CO₂ will be captured, so as to be comparable to other processes, the hourly water demand will be about 1485 metric tons per hour, or 6400 gallons per minute per MWe. Notably, using the methods and assumptions below and above, it is possible to specifically tailor a system with a set removal efficiency (i.e., 301, 501, 701, etc.).

In accordance with the method of the invention, the water will be provided in a cross-flow through the limestone bed, from the slots 24, through rows 12 to grated passages 34. The total cross-flow area needed is determined by the quotient of the volumetric flow of water divided by the superficial velocity, υₛ. As noted above, in a preferred embodiment, the water is maintained at about ⅔ meter. For a system to remove 90% of the CO₂ from a 150 MWe power plant, a water flow rate of about 220,000 metric tons of water per hour is required to pass through the bed 10. Using the equivalence of 1 metric ton of water per cubic meter, the volumetric flow rate of water is 220,000 m³ per hour. Dividing the volumetric flow rate by the superficial velocity of 32.5 meters per hour yields an area of 6,770 m². Then, since the water depth in the bed 10 is ⅔ m, the total length of the limestone bed 10 must be about 10,150 meters long, or about 10 km or 6.3 miles. Clearly, if the bed 10 were linear, siting problems as well as several flow-hydraulic problems would be created.

By arranging the limestone bed 10 in parallel rows 12, the same effective length may be obtained with a bed that is about 600 m×600 m, or roughly 40 rows 12 which are 600 meters long. Thus, the bed 10 described above embodies the necessary size for effectively removing about 90% of the CO₂ produced by a mid-size power plant.

The water supply and outlet channels 22, 32 are designed to permit using water supplies without having to expend additional energy to pump water through the bed 10. The water must initially be raised to a level sufficiently high to provide the driving force for the water through the bed 10. However, once the water is provided at the necessary level, the design of the channel walls 25, 35 will permit the force of gravity and fluid mechanics to move the water through the bed 10. Depending upon the location, the process water can come from a river, lake, ocean, or any other large reservoir or supply of water. Insofar as sequestration is the only concern (rather than water supplies or other mechanical concerns), it is not necessary to limit the location to a ocean-water or coastal areas.

In a preferred embodiment, the water will be raised about 50 cm above the liquid level in the limestone bed 10. Thus, if the outlets are provided 25 cm above the high tide level of the adjacent seawater at a coastal installation, the water must be raised 75 cm at high tide, and 75 cm plus the water height difference between the high and low tides at other times.

The invention essentially includes a bed having inlet and outlet channels, distribution means for introducing and distributing a flue gas containing CO₂ within the bed (preferably, through manifolds, the perforated pipes buried in the bed, etc.), a solvent supplied to the bed, chemical means disposed in the bed for assisting in the removal of CO₂ from the flue gas, means for dissolving removed CO₂ into a waste water supply, and means for disposing of the waste water containing dissolved CO₂ for dissipation, pH leveling, storage and/or other treatment.

Notably, the chemical means may be granulated limestone or any other substance known to those skilled in the art which would assist or affect the removal of CO₂ from the flue gas. Likewise the solvent is preferably water (either fresh, salt or a combination thereof), although a multitude of other solvents in which CO₂ dissolves will be known to those skilled in the art. The means for dissolving may be any physical apparatus which disperses and dissolves the captured CO₂ into the water supply, including but not limited to grates, atomizers and the like. Finally, the disposal means may be incorporated into the bed as a series of sloping channels which drive the water through the bed by the force of gravity, or alternative or additional pumps, pipes or other means which carry the waste water from the bed.

This system has advantages over the known CO₂ sequestration methods and apparati, including significantly lower parasitic power loss. The parasitic power loss associated with using the limestone bed 10 of the invention is about 1%, for about 90% CO₂ removal and disposal. The parasitic power is used for lifting 220,000 m³ of water per hour about 1.5 meters and bubbling 12,000 m³ per minute of flue gas against a hydrostatic head of 25 cm for a 150 MWe power plant.

Further, it is envisioned that the condenser cooling water used in a conventional once-through condenser system of a fossil fuel burning power plant can be recycled and used in the limestone bed 10 of the invention. The amount of water used in the bed 10 would have a temperature increase of no more than about 3° F. after passing through the condenser, so that the same hydraulic rules that apply to cooling water will apply to its use in the limestone bed 10. The intake and outlet must be sufficiently isolated from each other so that short-circuiting of the system is avoided.

Other advantages include the relatively simple adaptation of the system to existing plants. Unlike absorption/stripping processes, the presence of SO₂ in the flue gas is not a problem for the present invention. Some SO₂ in the flue gas passing through the limestone bed 10 of the present invention may actually facilitate the limestone dissolution rate and thereby benefit the CO₂ sequestration rate. In contrast, in absorption/stripping methods, SO₂ will react with most amine-based solvents to produce thermally stable amine-sulfur compounds which must be discarded and replaced; therefore, the power plant using absorption-stripping must add or upgrade the FGD system to achieve very high SO₂ efficiency to avoid excessive reagent costs.

It should be noted that the particular width and depth of the limestone bed rows 12, as well as the specific configuration of the overall bed 10 may be varied to meet site specific requirements in accordance with the formulae above without departing from the principles and scope of the invention. As mentioned above, the system may also be altered depending upon the desired removal efficiency

While a specific embodiment of the invention has been shown and described in detail to illustrate the application of the principles of the invention, it will be understood that the invention may be embodied otherwise without departing from such principles.

1. A system for removing and sequestering a preselected amount of carbon dioxide (CO₂) from a gas having an original CO₂ concentration, the system comprising:
a reaction bed;
distribution means for introducing a gas having an original concentration of CO₂ to the bed;
a CO₂ solvent supplied to the bed;
chemical means disposed within the bed for removing a preselected amount of CO₂ from the gas;
means for dissolving the removed, preselected amount of CO₂ into the solvent; and
means for disposing of a portion of the solvent which contains the removed, preselected and dissolved CO₂.

2. A system according to claim 1, wherein the distribution means comprises a plurality of perforated pipes.

3. A system according to claim 1, wherein the solvent is at least one selected from the group consisting of: fresh water, salt water and brackish water.

4. A system according to claim 1, wherein the chemical means comprises limestone.

5. A system according to claim 1, wherein the means for dissolving the CO₂ into the solvent comprises a series of drains integrated into the bed.

6. A system according to claim 1, wherein the means for disposing of the solvent includes transporting the portion of the solvent which contains the removed, preselected and dissolved CO₂ to at least one of: a CO₂ storage facility, a deep ocean location, an underground aquifer and a depleted gas well.

7. A system according to claim 1, wherein the means for disposing of the solvent is driven by gravitational forces.

8. A system according to claim 4, wherein the chemical means comprises limestone.

9. A system according to claim 8, wherein the limestone is granulated.

10. A system according to claim 9, wherein the granulated limestone comprises a plurality of stones of a discrete diameter and wherein the diameter of the stones is determined by a Sauter mean diameter calculation.

11. A system according to claim 1, wherein at least 90% of the original CO₂ concentration of the gas is dissolved in the portion of the solvent that is disposed of.

12. A system according to claim 1, wherein no more than 90% of the original CO₂ concentration of the gas is dissolved in the portion of the solvent that is disposed of.

13. An apparatus having a defined reaction bed for removing and sequestering CO₂ from a gas, the apparatus comprising:
a plurality of inlet channels having a defined length and height;
means for supplying water at a controlled flow rate into at least one inlet channel;
chemical means for removing CO₂ from a gas having an original concentration of CO₂, the chemical means being in fluidic contact with at least one inlet channel;
distribution means for distributing the gas so that the gas comes into contact with the chemical means;
a plurality of outlet channels having a defined length and height located proximate to the chemical means; and
means for transporting the water from the chemical means into at least one outlet channel, the means for transporting the water being in fluidic contact with the chemical means.

14. An apparatus according to claim 13, wherein the distribution means comprises a plurality of perforated pipes.

15. An apparatus according to claim 13, wherein the means for transporting the water comprises at least one drain grate.

16. An apparatus according to claim 13, wherein the number, length and height of at least one of: the inlet channels and the outlet channels, is determined by the flow rate of the water divided by a superficial velocity of the water.

17. An apparatus according to claim 13, wherein at least 90% of the original CO₂ concentration of the gas is dissolved in the water transported to the outlet channels.

18. An apparatus according to claim 13, wherein no more than 90% of the original CO₂ concentration of the gas is dissolved in the water transported to the outlet channels.

19. An apparatus according to claim 13, wherein the water is supplied from at least one selected from the group consisting of: a fresh water source, a salt water source and a brackish water source.

20. An apparatus according to claim 13, wherein the means for transporting the water is driven by gravitational forces.
